(19) United States
(12) Patent Application Publication
(10) Pub. No.: US 2011/0022723 A1
(43) Pub. Date: Jan. 27, 2011

(54) INFORMATION PROCESSING APPARATUS THAT PERFORMS DATA TRANSMISSION USING SIP, METHOD OF CONTROLLING THE SAME, AND STORAGE MEDIUM

(75) Inventor: Yutaka Inoue, Tokyo (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/841,615

(22) Filed: Jul. 22, 2010

(30) Foreign Application Priority Data
Jul. 23, 2009 (JP) 2009-172209

(51) Int. Cl. G06F 15/173; G06F 21/00

(52) U.S. Cl. 709/238; 726/3

(57) ABSTRACT

An information processing apparatus which enables a user on a source side to transmit data to a redirect destination terminal if the user on the source side desires to perform data transmission, even when a redirect setting has been made by the destination side. A CPU of the information processing apparatus determines whether or not a redirect setting for redirecting data to a redirect destination terminal has been made concerning a destination terminal as a data transmission destination, When the CPU judges that the redirect setting has been made, it queries a user whether or not to permit data transmission to the redirect destination terminal, for selection. When permission of the data transmission to the redirect destination terminal has been selected, the CPU permits the data transmission to the redirect destination terminal.

### BACKGROUND OF THE INVENTION

1. Field of the Invention

The present invention relates to an information processing apparatus which performs data transmission using SIP (Session Initiation Protocol) as a communication control protocol, and a method of controlling the image forming apparatus.

2. Description of the Related Art

In a case where communication is performed using SIP, a SIP server is provided between a source terminal and a destination terminal, and the source terminal queries the SIP server as to an IP address of the destination terminal to thereby acquire the IP address and request the destination terminal for connection.

Under the above-mentioned communication environment, the destination terminal can make a redirect setting in the SIP server.

The redirect setting is made e.g. when a user on a destination side has to go out and desires to receive data addressed to the user not by the user's normal destination terminal, but by a terminal outside the user's house or office when he is out. In this case, the user registers the IP address of the terminal outside the user's house or office as a redirect destination in the SIP server in advance. Thus, when receiving a query from a source terminal, the SIP server notifies the source terminal of the IP address of the redirect destination terminal.

However, when data is transferred from a source terminal to a terminal outside a user's house or office, which means that the data is sent to a terminal different from a terminal intended by a sender, a problem occurs from the viewpoint of security.

To solve this problem, there has been proposed a technique, in which if a source terminal querying the SIP server is notified that a redirect setting has been made by a destination side, communication is discontinued (see Japanese Patent Laid-Open Publication No. 2005-94662).

However, the technique disclosed in Japanese Patent Laid-Open Publication No. 2005-94662 is inconvenient in that communication is discontinued if a redirect setting has been made by a destination side, in spite of the fact that a user on a source (sending) side desires to transmit data to a destination which is changed to a terminal outside a recipient's house or office by the redirect setting.

Japanese Patent Laid-Open Publication No. 2005-94662 also discloses a method in which a “permitted address” is registered for permitting data transmission thereto by way of exception even when a redirect setting has been made by a destination side. However, it is not practical that a user (or an administrator) on a source side should think of a redirect destination in advance which a user on a destination side can set as desired.

### SUMMARY OF THE INVENTION

The present invention provides an information processing apparatus which enables a user on a source side to transmit data to a redirect destination terminal if the user on the source side desires to perform data transmission, even when a redirect setting has been made by the destination side, a method of controlling the information processing apparatus, and a non-transitory computer-readable storage medium storing a program for causing a computer to execute the method.

In a first aspect of the present invention, there is provided an information processing apparatus that performs data transmission using SIP as a communication control protocol, comprising a judgment unit adapted to judge whether or not a redirect setting for redirecting data to a redirect destination terminal has been made concerning a destination terminal as a data transmission destination, an inquiry unit adapted to be operable when the judgment unit judges that the redirect setting has been made, to query a user whether or not to permit data transmission to the redirect destination terminal, for selection, and a transmission control unit adapted to be operable when permission of the data transmission to the redirect destination terminal has been selected via the inquiry unit, to permit the data transmission to the redirect destination terminal.

In a second aspect of the present invention, there is provided a method of controlling an information processing apparatus that performs data transmission using SIP as a communication protocol, comprising judging whether or not a redirect setting for redirecting data to a redirect destination terminal has been made concerning a destination terminal as a data transmission destination, querying, when it is judged that the redirect setting has been made, a user whether or not to permit data transmission to the redirect destination terminal, for selection, and permitting, when permission of the data transmission to the redirect destination terminal has been selected, the data transmission to the redirect destination terminal.

In a third aspect of the present invention, there is provided a non-transitory computer-readable storage medium storing a program for causing a computer to execute a method of controlling an information processing apparatus which performs data transmission using SIP as a communication protocol, wherein the method comprises judging whether or not a redirect setting for redirecting data to a redirect destination terminal has been made concerning a destination terminal as a data transmission destination, querying, when it is judged that the redirect setting has been made, a user whether or not to permit data transmission to the redirect destination terminal, for selection, and permitting, when permission of the data transmission to the redirect destination terminal has been selected, the data transmission to the redirect destination terminal.

According to the present invention, when a redirect setting has been made by the destination side, a query is issued to the user on the source side as to whether or not data is to be transmitted, and only when the user on the source side permits the data transmission, the data is transmitted.

With this configuration, even in a case where a redirect setting has been made by the destination side, the user on the source side can transmit data to the redirect destination terminal if he/she desires. This makes it possible to improve user friendliness while maintaining the security function.

Further features of the present invention will become apparent from the following description of exemplary embodiments (with reference to the attached drawings).

### BRIEF DESCRIPTION OF THE DRAWINGS

FIG. 1 is a schematic diagram of a communication system including an information processing apparatus according to a first embodiment of the present invention.

FIG. 2 is a block diagram of an MFP-X.

FIG. 3 is a sequence diagram useful in explaining processing executed for FAX transmission from the MFP-X to an MFP-A.

FIG. 4 is a sequence diagram useful in explaining processing executed for FAX transmission from the MFP-X to the MFP-A in a case where an MFP-C is set as a redirect destination for the MFP-A.

FIG. 5 is a flowchart of a data transmission process executed by the MFP-X as a source terminal.

FIG. 6 is a view illustrating an example of a query screen displayed for a user.

FIG. 7 is a view illustrating an example of a display of a message indicating that transmission has been stopped.

FIG. 8 is a view illustrating an example of a screen displayed on an information processing apparatus according to a second embodiment of the present invention, for pre-configuring a setting of whether or not to query the user as to whether data transmission to a redirect destination is to be permitted or disabled.

FIG. 9 is a flowchart of a data transmission process executed by the MFP-X as a source terminal.

FIGS. 10A and 10B are diagrams useful in explaining an information processing apparatus according to a third embodiment of the present invention, in which FIG. 10A shows a permitted address list of redirect destination addresses to which data transmission is permitted, and FIG. 10B shows an inhibited address list of redirect destination addresses to which is data transmission inhibited.

FIG. 11 is a flowchart of a data transmission process executed by the MFP-X as a source terminal.

FIG. 12 is a flowchart of a data transmission process executed by the MFP-X forming an information processing apparatus according to a fourth embodiment of the present invention.

FIG. 13 is a flowchart of a data transmission process executed by the MFP-X forming an information processing apparatus according to a fifth embodiment of the present invention.

FIG. 14 is a view illustrating an example of a configuration screen which is displayed on a display section of the MFP-X forming an information processing apparatus according to a sixth embodiment of the present invention, during memory transmission, for enabling a user to configure whether or not to permit data transmission to an redirect destination.

FIG. 15 is a flowchart of a data transmission process executed by the MFP-X which is a source terminal.

FIG. 16 is a flowchart of a data transmission process executed by the MFP-X forming an information processing apparatus according to a seventh embodiment of the present invention.

FIG. 17 is a diagram showing an example of discontinued-transmission history information stored in a storage unit.

FIG. 18 is a view illustrating an example of a notification screen for displaying a notification to the user.

### DETAILED DESCRIPTION OF THE EMBODIMENTS

The present invention will now be described in detail below with reference to the accompanying drawings showing embodiments thereof.

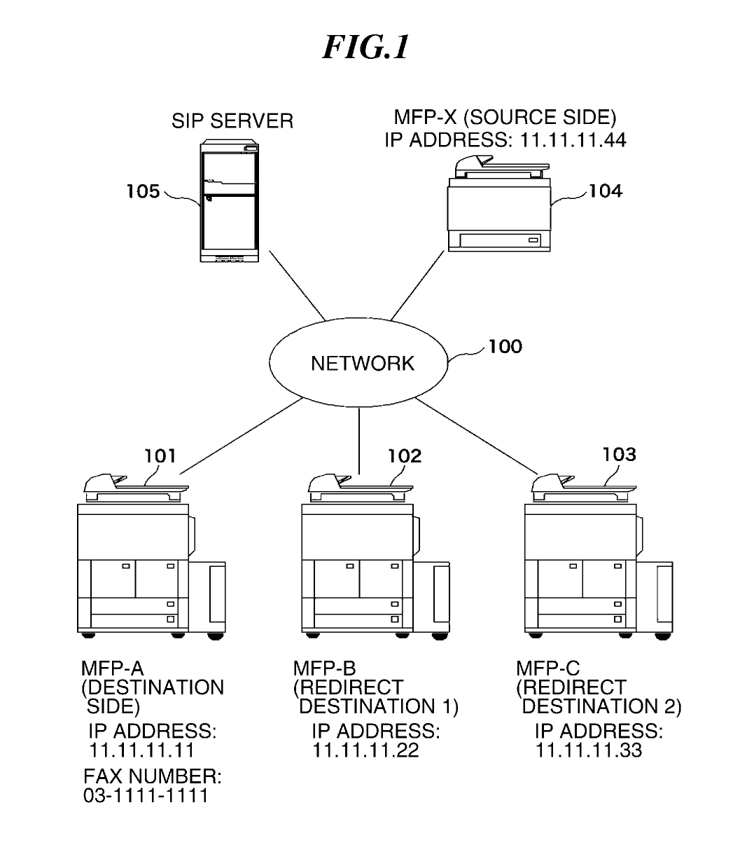

FIG. 1 is a schematic diagram of a communication system including an information processing apparatus according to a first embodiment of the present invention.

In the communication system shown in FIG. 1, an MFP (Multifunction Peripheral)-A 101, an MFP-B 102, an MFP-C 103, an MFP-X 104, and a SIP server 105 each capable of performing communication using SIP (Session Initiation Protocol) for a communication control protocol are communicably interconnected via a network 100.

The MFP-A 101, the MFP-B 102, the MFP-C 103, and the MFP-X 104 are each equipped with a copy function, a FAX function, and a printing function.

Further, in the illustrated communication system, it is assumed that the MFP-A 101 is a destination terminal, the MFP-B 102 and the MFP-C 103 are redirect destination terminals, and the MFP-X 104 is a source terminal. In the present embodiment, the MFP-X 104 corresponds to an example of the information processing apparatus according to the present invention. It should be noted that the MFP-A 101 is assigned a FAX number “03-1111-1111”.

The SIP server 105 is a combination of a redirect server, a proxy server, a registration server, and a location server, none of which are particularly shown. Further, the SIP server 105 performs the management of registration of each user terminal, user authentication, the conversion of a telephone or FAX number to an IP address, the control of a call control sequence, routing to a connection destination, and so forth.

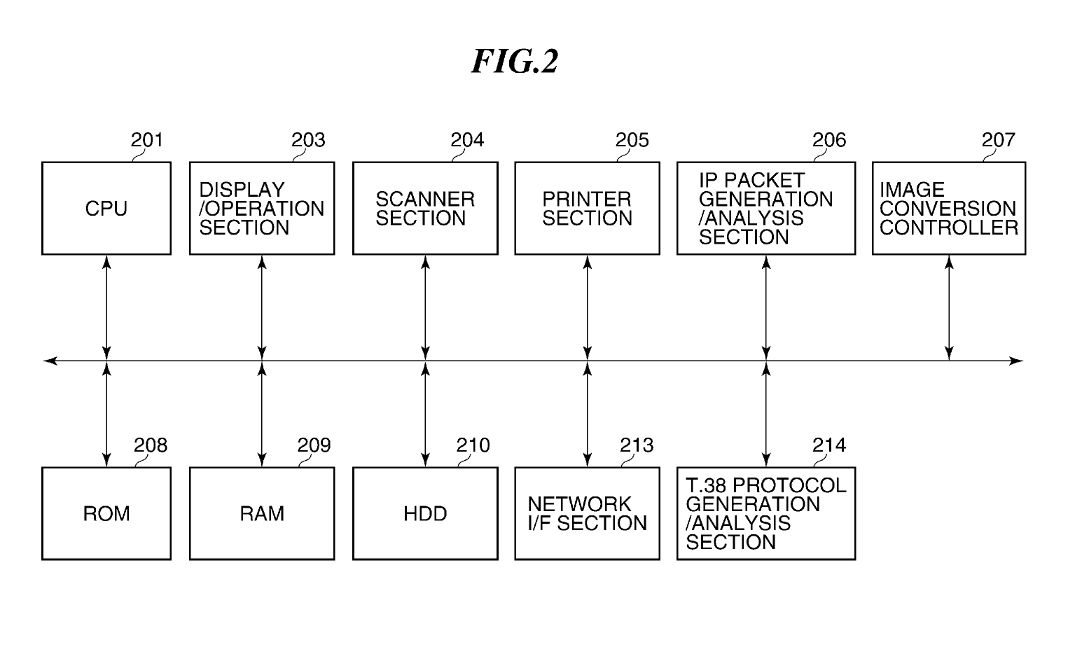

FIG. 2 is a block diagram useful in explaining an example of the configuration of the MFP-X 104. The configurations of the MFP-A 101, the MFP-B 102, and the MFP-C 103 are the same as that of the MFP-X 104, and hence description thereof is omitted.

Referring to FIG. 2, a CPU 201 controls each component device of the MFP-X 104 based on a control program stored in a ROM 208.

A display/operation section 203 displays e.g. windows, icons, messages, menus, and other user interface information, on a display screen thereof. The display/operation section 203 comprises various kinds of keys, not shown, via which the user performs an operation for copying, FAX transmission and printing, and a screen pointing device, not shown, by which the user operates an icon, a menu, etc. displayed on the display screen.

A scanner section 204 reads an image from an original. A printer section 205 prints print out data stored in a RAM (Random Access Memory) 209 or a HDD (Hard Disk Drive) 210. The ROM (Read Only Memory) 208 stores various kinds of control programs and data.

The RAM 209 has a work area for the CPU (Central Processing Unit) 201, a data save area for use in error handling, a load area for loading control programs, and the like. The HDD 210 stores various kinds of control programs and print data.

A network interface (I/F) section 213 is connected to the network 100, and performs communication with the SIP server 105, the MFP-A 101, the MFP-B 102, and the MFP-C 103. The network interface section 213 also performs communication for SIP-FAX.

A T.38 protocol generation/analysis section 214 has the function of generating FAX transmission information that is to be transmitted according to a protocol defined by ITU-T (International Telecommunication Union Telecommunication Standardization Sector) Recommendation T.38, extracting FAX transmission information from a received protocol.

An IP packet generation/analysis section 206 has the function of mapping the protocol defined in ITU-T Recommendation T.38 to IP packets, and further extracting the protocol defined in the ITU-T Recommendation T.38 from received IP packets. An image conversion controller 207 performs the compression, expansion, zooming and linear density conversion of images to be transmitted and received by FAX communication.

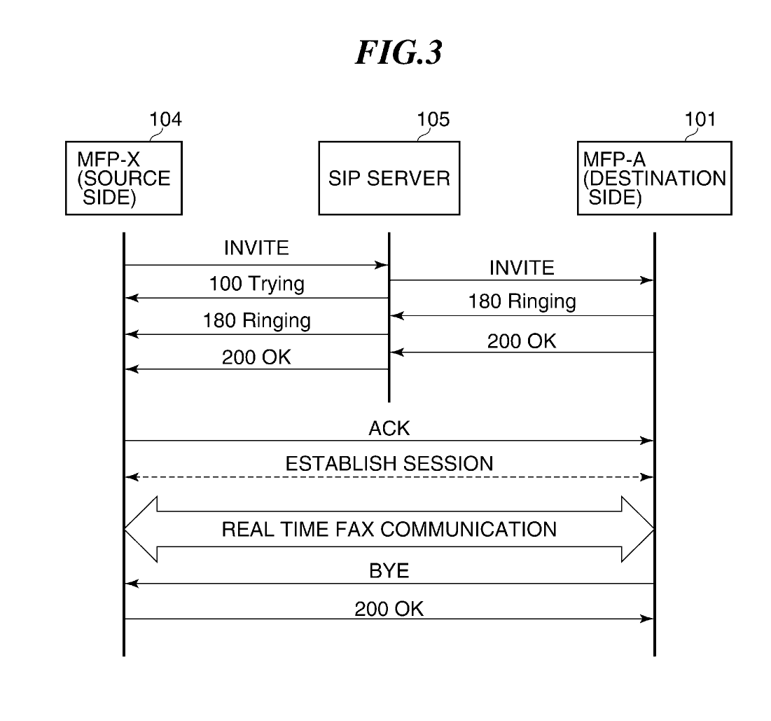

FIG. 3 is a sequence diagram useful in explaining processing executed for FAX transmission from the MFP-X 104 to the FAX number “03-1111-1111” of the MFP-A 101 which is a data transmission destination.

Referring to FIG. 3, first, the MFP-X 104 sends an INVITE request to establish a session with the FAX number “03-1111-1111” of the MFP-A 101 which is the data transmission destination, to the SIP server 105.

The SIP server 105 identifies an IP address “11.11.11.11” of the MFP-A 101 from the FAX number “03-1111-1111” and sends the INVITE request to the MFP-A 101.

Further, the SIP server 105 provisionally sends a 100 Trying Response to the MFP-X 104, thereby notifying the MFP-X 104 that the SIP server 105 is attempting to connect to the MFP-A 101.

Upon receipt of the INVITE request from the SIP server 105, the MFP-A 101 starts a FAX reception process, and returns a 180 Ringing Response, which indicates that a callee is being alerted, to the SIP server 105.

The SIP server 105 routes the above-mentioned 180 Ringing Response returned from the MFP-A 101, thereby transmitting the same to the MFP-X 104.

The MFP-A 101 starts receiving FAX, and sends a 200 OK Response to the MFP-X 104 via the SIP server 105.

Upon receipt of the 200 OK Response, the MFP-X 104 sends ACK acknowledging the receipt of the 200 OK Response to the MFP-A 101.

The reception of ACK by the MFP-A 101 establishes the session between the MFP-X 104 and the MFP-A 101, whereafter real-time FAX communication is performed in compliance with ITU-T Recommendation T.38.

After completing FAX reception, the MFP-A 101 transmits a BYE method to the MFP-X 104. In response to this BYE method, the MFP-X 104 returns the 200 OK Response to the MFP-A 101, followed by terminating the session.

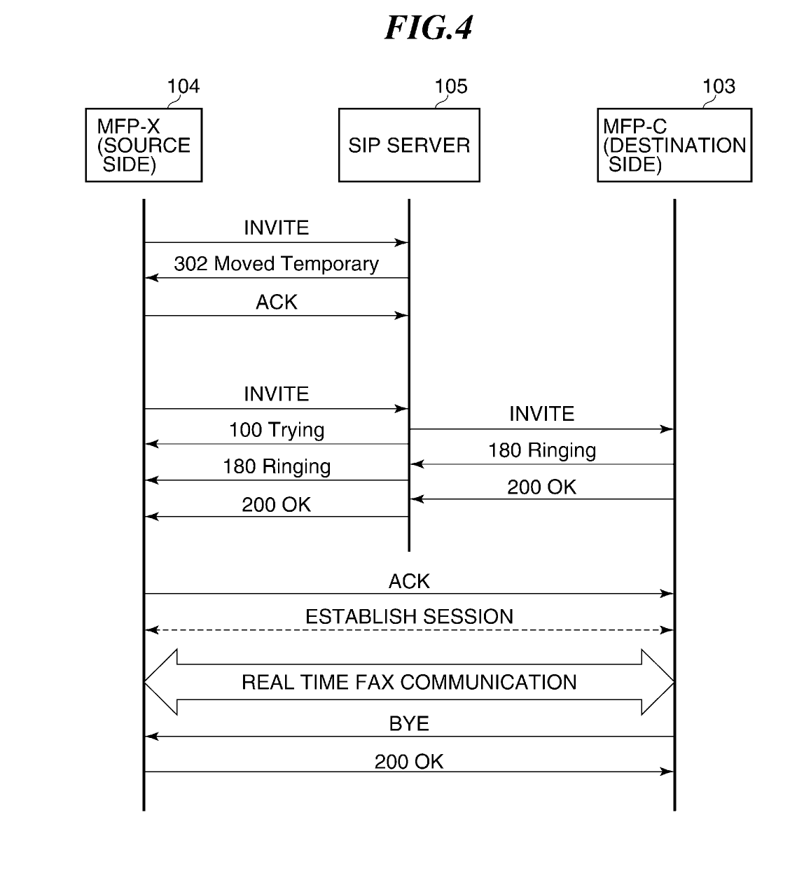

Next, a description will be given of processing executed in a case where FAX transmission is attempted from the MFP-X 104 to the FAX number “03-1111-1111” of the MFP-A 101 for which the MFP-C 103 has been set as a redirect destination, with reference to FIG. 4. It should be noted that description of processing executed by the MFP-A 101 for setting a redirect destination in the SIP server 105 is omitted here.

Referring to FIG. 4, first, the MFP-X 104 sends an INVITE request to establish a session with the FAX number “03-1111-1111” of the MFP-A 101 to the SIP server 105.

In response to the INVITE request sent from the MFP-X 104, the SIP server 105 returns a 302 Moved Temporary Response (redirect response) to the MFP-X 104.

At this time, the SIP server 105 refers to redirect destination setting information, and returns not only the 302 Moved Temporary Response but also the IP address of the redirect destination terminal for the FAX number “03-1111-1111” of the MFP-A 101, to the MFP-X 104.

In this case, an IP address “11.11.11.33” of the MFP-C 103 which is set to the destination of the redirect transmission is returned to the MFP-X 104.

Then, the MFP-X 104 transmits an acknowledgement response “ACK” to the SIP server 105 as a response to the 302 Moved Temporary Response returned from the SIP server 105.

The MFP-X 104 further transmits an INVITE request to the SIP server 105 again. The IP address of a destination terminal this time is the above-mentioned received IP address, i.e. the IP address “11.11.11.33” of the MFP-C 103.

The SIP server 105 routes the INVITE request sent from the MFP-X 104 to thereby send the same to the MFP-C 103, which is the redirect destination. Further, the SIP server 105 provisionally returns a 100 Trying Response to the MFP-X 104, thereby notifying the MFP-X 104 that the SIP server 105 is attempting to connect to the MFP-C 103.

Upon receipt of the INVITE request from the SIP server 105, the MFP-C 103 starts a FAX reception process, and returns a 180 Ringing Response, which indicates that a callee is being alerted, to the SIP server 105.

The SIP server 105 routes the 180 Ringing Response returned from the MFP-C 103 to thereby send the same to the MFP-X 104.

The MFP-C 103 starts receiving FAX, and returns a 200 OK Response to the MFP-X 104 via the SIP server 105.

Upon receipt of the 200 OK Response, the MFP-X 104 sends ACK acknowledging the receipt of the 200 OK Response to the MFP-C 103.

The reception of ACK by the MFP-C 103 establishes the session between the MFP-X 104 and the MFP-C 103, whereafter real-time FAX communication is performed in compliance with ITU-T Recommendation T.38.

After completing FAX reception, the MFP-C 103 transmits a BYE method to the MFP-X 104. In response to this BYE method, the MFP-X 104 sends the 200 OK Response to the MFP-C 103, followed by terminating the session.

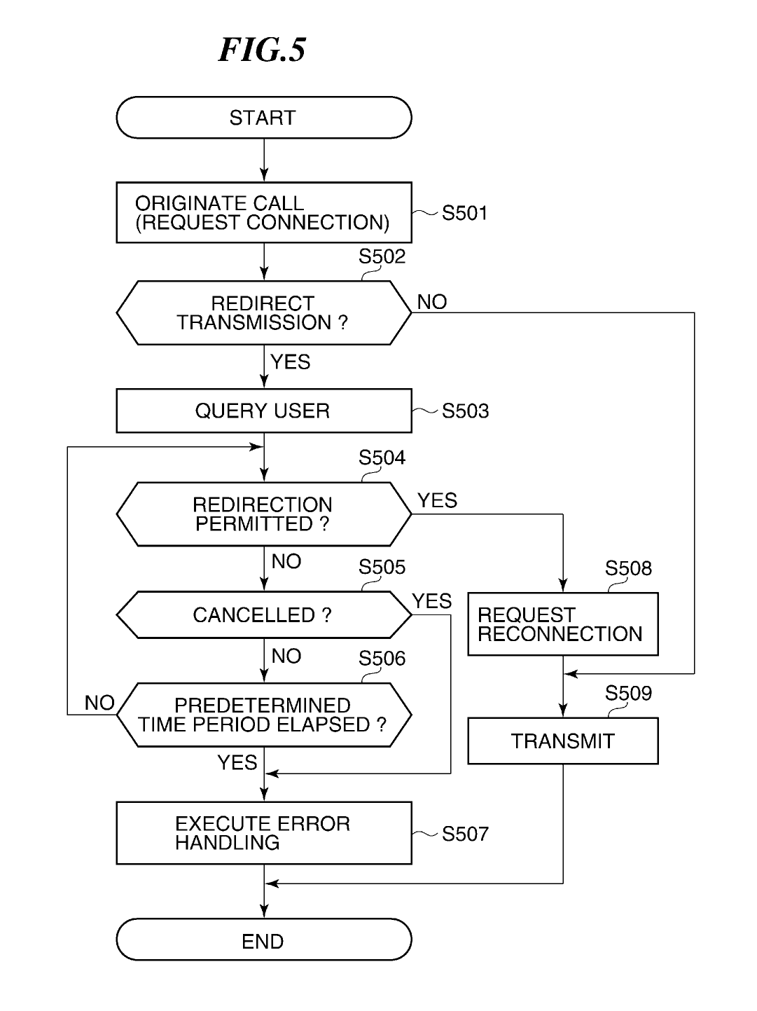

Next, a description will be given of a data transmission process executed by the MFP-X 104 which is a source terminal, with reference to FIG. 5. Processing in each step of the process in FIG. 5 is executed e.g. by the CPU 201, by loading a control program stored in a storage unit of the MFP-X 104, such as the ROM 208 or the HDD 210, into the RAM 209.

In a step S501, when the CPU 201 accepts a transmission instruction issued by an operation performed by a user e.g. on the display/operation section 203, for transmission, it transmits an INVITE request for establishment of a session, to the SIP server 105, and then proceeds to a step S502.

In the step S502, the CPU 201 determines whether or not an alternative address (e.g. an IP address) set by the redirect setting is notified from the SIP server 105.

Specifically, if no alternative address is contained in the 302 Moved Temporary Response returned from the SIP server 105, the CPU 201 determines that no redirect setting has been made, and transmits data in a step S509, followed by terminating the present process.

On the other hand, if an alternative address is contained in the 302 Moved Temporary Response returned from the SIP server 105, the CPU 201 determines that a redirect setting has been made, and proceeds to a step S503.

In the step S503, the CPU 201 causes the display/operation section 203 to display a screen for querying the user to determine whether or not to transmit the data to a redirect destination terminal designated in the redirect setting, and then proceeds to a step S504.

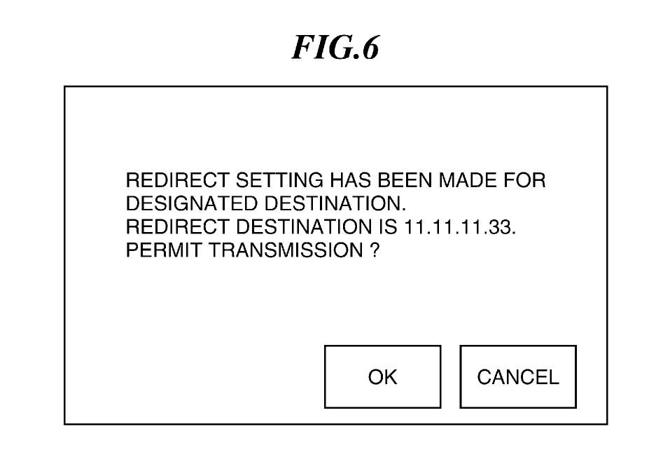

FIG. 6 illustrates an example of a query screen displayed on the display of the display/operation section 203. On the screen shown in FIG. 6 by way of example, the CPU 201 notifies the user that a redirect setting has been made in the transmission destination terminal, and displays the address (e.g. the IP address) of a redirect destination, and an “OK” button and a “Cancel” button for selection as to whether or not to permit transmission to this address.

If it is determined in the step S504 that the “OK” button has been selected on the FIG. 6 screen, the CPU 201 proceeds to a step S508, whereas if not, the CPU 201 proceeds to a step S505.

In the step S508, the CPU 201 sends an INVITE request for reconnection to the address of the redirect destination to the SIP server 105, and then proceeds to the step S509.

In the step S509, the CPU 201 transmits the data to the redirect destination terminal, followed by terminating the present process.

On the other hand, in the step S505, the CPU 201 determines whether or not the “Cancel” button has been selected on the FIG. 6 screen.

If the “Cancel” button has been selected, the CPU 201 proceeds to a step S507, whereas if not, the CPU 201 proceeds to a step S506.

If it is determined in the step S506 that a state where neither the “OK” button nor the “Cancel” button is not operated on the FIG. 6 screen has continued over a predetermined time period, the CPU 201 proceeds to the step S507.

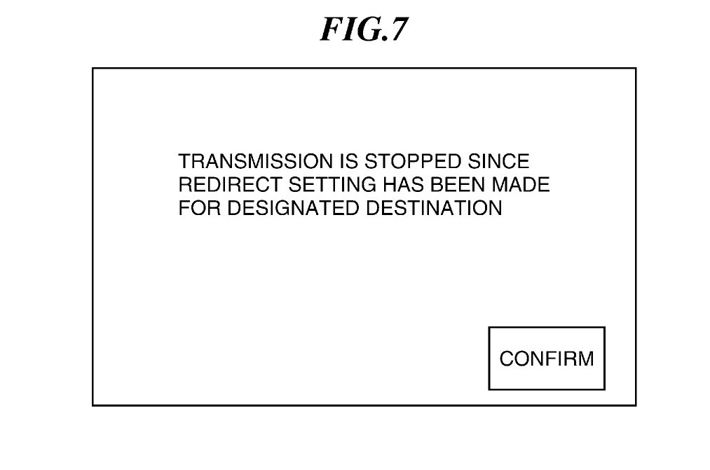

In the step S507, the CPU 201 causes the display/operation section 203 to display a message indicating that the transmission has been stopped, e.g. as shown in FIG. 7, to thereby execute error handling, followed by terminating the present process without performing data transmission.

As described above, in the present embodiment, when a redirect setting has been made by the destination side, the user on the source side is queried whether or not to permit data transmission, and only when the user on the source side permits the data transmission, data is transmitted.

With this configuration, even in a case where a redirect setting has been made by a destination side, if a user on a source side desires data transmission, data can be transmitted to a redirect destination terminal, which makes it possible to improve user friendliness while maintaining the security function.

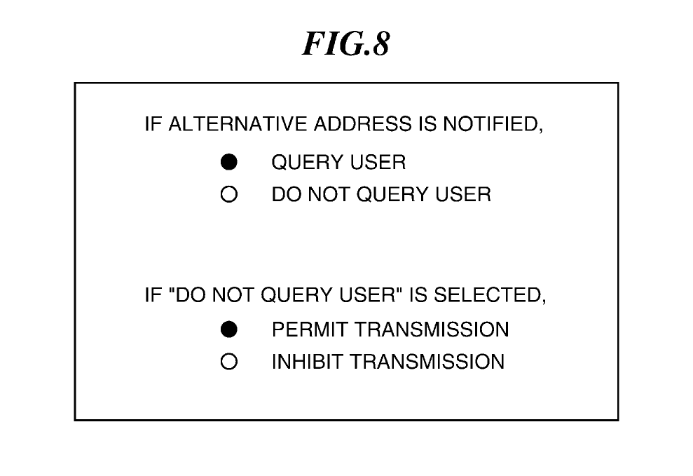

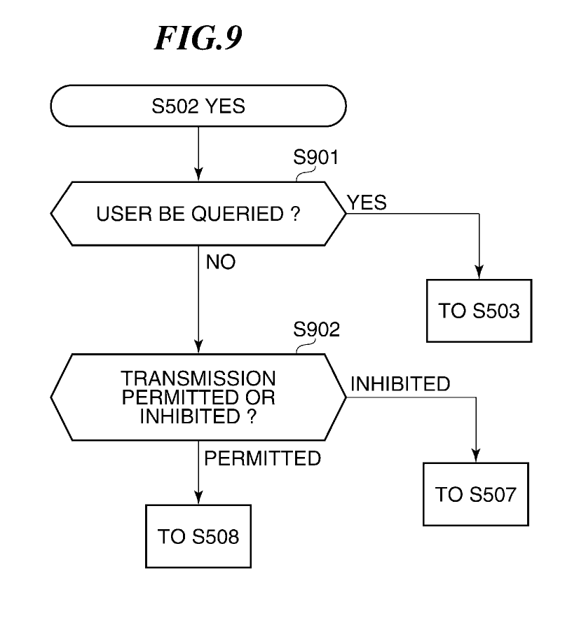

Next, an information processing apparatus according to a second embodiment will be described with reference to FIGS. 8 and 9. It should be noted that component parts and elements identical or corresponding to those of the first embodiment will be denoted by identical reference numerals, and description thereof will be given using the figures referred to in describing the first embodiment.

In the present embodiment, a description will be given of an example of pre-configuration of whether or not to query the user of the MFP-X 104 which is a source terminal as to whether or not data transmission to a redirect destination is to be permitted when a redirect setting has been made by a destination side.

FIG. 8 illustrates an example of a screen displayed on the display of the display/operation section 203 of the MFP-X 104. On this screen, there are disposed softswitches, such as touch keys for selection between options “QUERY USER” and “DO NOT QUERY USER”, so as to enable the user to touch one of them to thereby select whether or not to be queried when an alternative address of a redirect destination is sent from the SIP server 105.

On the left side of each of these options by the touch keys, there is displayed an indicator indicative of the selection by touching, for confirmation by the user. The FIG. 8 screen shows an example in which the option “QUERY USER” is selected as a first setting to cause the user to be queried when an alternative address of a redirect destination is notified from the SIP server 105.

When the option “DO NOT QUERY USER” is selected in an upper area of the FIG. 8 screen to set the same, the option “PERMIT TRANSMISSION” or the option “INHIBIT TRANSMISSION” in a lower area of the same is selected by touching the associated touch key, whereby permission or inhibition of data transmission to the redirect destination is set, as a second setting.

In this case as well, on the left side of each of the options by the touch keys, there is displayed an indicator indicative of the selection by touching, for confirmation by the user. The illustrated example shows that when “DO NOT QUERY” is selected in the upper area, the permission of data transmission to the redirect destination has been set.

When the permission of data transmission is selected on the FIG. 8 screen, the data transmission to the redirect destination is permitted without querying the user, whereas when the inhibition of data transmission to the redirect destination is selected on the FIG. 8 screen, the data transmission to the redirect destination is inhibited without querying the user.

Next, a description will be given of a data transmission process executed by the MFP-X 104 which is a source terminal, with reference to FIG. 9. Processing in each step of the process in FIG. 9 is executed e.g. by the CPU 201, by loading a control program stored in the storage unit of the MFP-X 104, such as the ROM 208 or the HDD 210, into the RAM 209.

In the present embodiment, the data transmission process is identical to that (FIG. 5) in the first embodiment except that steps S901 and S902 are inserted between the steps S502 and S503 in FIG. 5, and therefore the following description will be given only of different points.

When an alternative address is notified by the 302 Moved Temporary Response returned from the SIP server 105, first, the CPU 201 determines in the step S502 that a redirect setting has been made, and proceeds to the step S901.

In the step S901, the CPU 201 determines which of the option “QUERY USER” and the option “DO NOT QUERY USER” has been selected on the FIG. 8 screen.

If the option “QUERY USER” has been selected, the CPU 201 proceeds to the step S503, wherein the CPU 201 executes the same query processing as in FIG. 5. On the other hand, if the option “DO NOT QUERY USER” has been selected, the CPU 201 proceeds to the step S902.

In the step S902, the CPU 201 determines which of the option “PERMIT TRANSMISSION” and the option “INHIBIT TRANSMISSION” has been selected on the FIG. 8 screen as to data transmission to a redirect destination.

If the option “PERMIT TRANSMISSION” has been selected for permitting data transmission to the redirect destination, the CPU 201 proceeds to the step S508, wherein the CPU 201 requests reconnection. On the other hand, if the option “INHIBIT TRANSMISSION” has been selected for inhibiting data transmission to the redirect destination, the CPU 201 proceeds to the step S507, wherein the CPU 201 executes error handling, without transmitting data to the redirect destination.

As described above, in the present embodiment, when a redirect setting has been made by a destination side, it is possible not only to select whether or not to query the user of a source terminal as to whether or not to permit data transmission to a redirect destination, but also to specify a transmission operation to be performed in the case where the user is not to be queried, which contributes to improvement of user friendliness in data transmission. The other constructions and advantageous effects of the present embodiment are the same as described hereinabove as to the first embodiment.

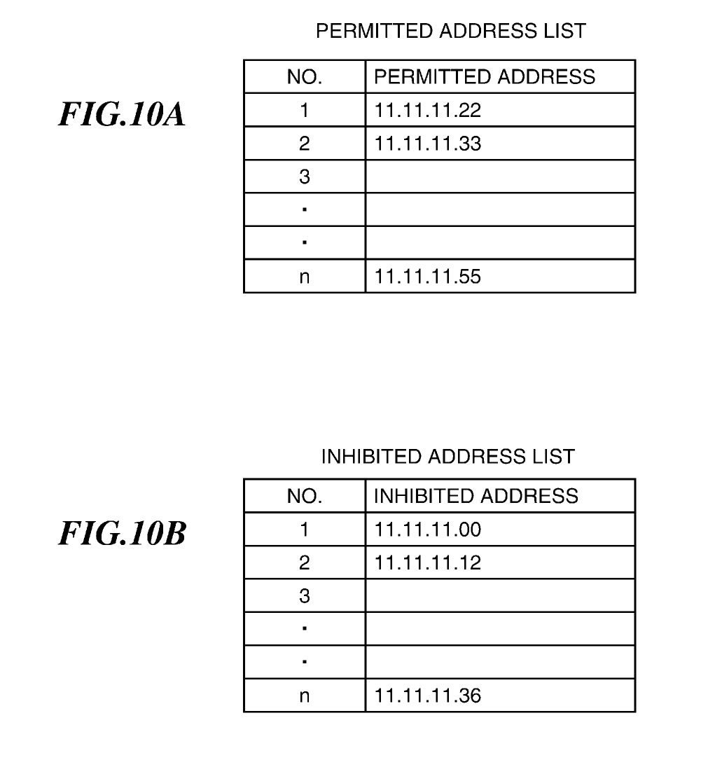

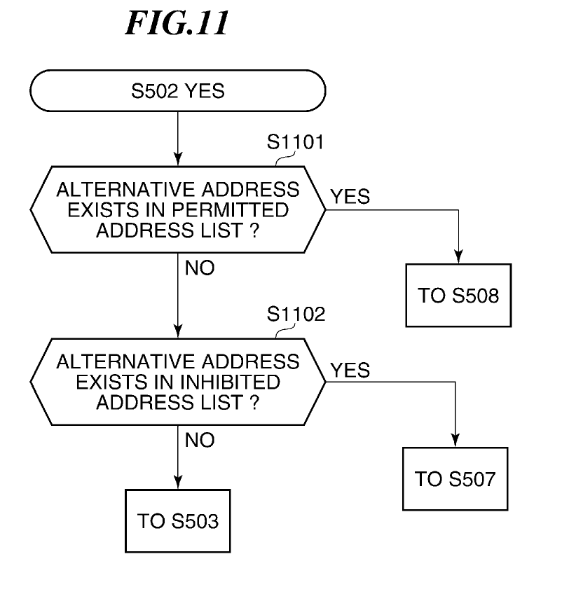

Next, an information processing apparatus according to a third embodiment will be described with reference to FIGS. 10A, 10B, and 11. It should be noted that component parts and elements identical or corresponding to those of the first embodiment will be denoted by identical reference numerals, and description thereof will be given using the figures referred to in describing the first embodiment.

In the present embodiment, there are configured in advance a permitted address list (FIG. 10A) of redirect destination addresses to which data transmission is permitted and an inhibited address list (FIG. 10B) of redirect destination addresses to which data transmission is inhibited.

Then, an alternative address notified from the SIP server 105 is checked against the addresses in these lists, whereby processing for querying a user before transmission is controlled.

Each of the addresses shown in FIGS. 10A and 10B is the IP address of a redirect destination. A predetermined program refers to transmission history or the like to perform judgment on each of addresses as to whether the user will permit or inhibit data transmission thereto, and based on the judgment, forms the permitted address list and the inhibited address list to store them in a predetermined storage area in advance.

Next, a description will be given of a data transmission process executed by the MFP-X 104 as a source terminal, with reference to FIG. 11. Processing in each step of the process in FIG. 11 is executed e.g. by the CPU 201, by loading a control program stored in the storage unit of the MFP-X 104, such as the ROM 208 or the HDD 210, into the RAM 209.

In the present embodiment, the data transmission process is identical to that (FIG. 5) in the first embodiment except that steps S1101 and S1102 are inserted between the steps S502 and S503 in FIG. 5, and therefore the following description will be given only of different points.

When an alternative address is notified by the 302 Moved Temporary Response returned from the SIP server 105, first, the CPU 201 determines in the step S502 that a redirect setting has been made, and proceeds to the step S1101.

In the step S1101, the CPU 201 checks the alternative address received in the step S502 against the permitted address list shown in FIG. 10A.

If the alternative address exists in the permitted address list, the CPU 201 proceeds to the step S508, wherein the CPU 201 requests reconnection. On the other hand, if the alternative address does not exist in the permitted address list, the CPU 201 proceeds to the step S1102.

In the step S1102, the CPU 201 checks the alternative address received in the step S502 against the inhibited address list shown in FIG. 103.

If the alternative address exists in the inhibited address list, the CPU 201 proceeds to the step S507, wherein the CPU 201 executes the error handling. On the other hand, if the alternative address does not exist in the inhibited address list, the CPU 201 proceeds to the step S503, wherein the CPU 201 queries the user.

In the present embodiment, the permitted address list of redirect destination addresses to which data transmission is permitted and the inhibited address list of redirect destination addresses to which data transmission is inhibited are set in advance, and before performing data transmission, the address of a redirect destination is checked against the permitted address list and the inhibited address list, as described above, whereby it is possible to control whether or not to query a user or whether to permit or inhibit data transmission to a redirect destination.

This makes it possible to manage redirect destination addresses, and dispense with query processing for querying a user insofar as addresses existing in the address lists are concerned, which contributes to improvement of user friendliness. The other constructions and advantageous effects of the present embodiment are the same as described hereinabove as to the first embodiment.

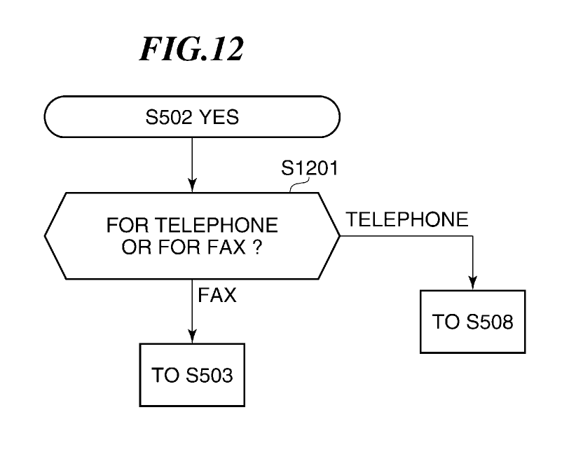

Next, an information processing apparatus according to a fourth embodiment will be described with reference to FIG. 12. It should be noted that component parts and elements identical or corresponding to those of the first embodiment will be denoted by identical reference numerals, and description thereof will be given using the figures referred to in describing the first embodiment.

In general, an MFP is equipped with a facsimile function and a telephone function, and a user of a destination terminal who makes a redirect setting in the SIP server 105 can make not only a redirect setting for FAX transmission but also a redirect setting for telephone communication (telephone call).

Therefore, in the present embodiment, redirect processing is switchingly controlled according to whether a connection request is for telephone communication or for FAX transmission.

When the user requests connection from the MFP-X 104 as a source terminal, it is possible to determine, based on the user operation, whether the connection request is for telephone communication (telephone call) or for data transmission (FAX transmission).

For example, in a case where a telephone number is designated for a connection request, when the connection request is for telephone communication (manual call origination), the user performs an operation, such as depression of a hook button of the display/operation section 203 or hookup of a handset, to thereby connect the MFP-X 104 to the line. When the connection request is for FAX transmission (automatic call origination), the user inputs the telephone number, sets a document, and then presses a transmission start button.

Next, a description will be given of a data transmission process executed by the MFP-X 104 which is a source terminal, with reference to FIG. 12. Processing in each step of the process in FIG. 12 is executed e.g. by the CPU 201, by loading a control program stored in the storage unit of the MFP-X 104, such as the ROM 208 or the HDD 210, into the RAM 209.

In the present embodiment, the data transmission process is identical to that (FIG. 5) in the first embodiment except that a step S1201 is inserted between the steps S502 and S503 in FIG. 5, and therefore the following description will be given only of different points.

When an alternative address is notified by the 302 Moved Temporary Response returned from the SIP server 105, the CPU 201 determines in the step S502 that a redirect setting has been made, and proceeds to the step S1201.

In the step S1201, the CPU 201 determines, based on the above-described operation by the user, whether the connection request is for telephone communication (telephone call) or for data transmission (FAX transmission).

If the connection request is for telephone communication, the CPU 201 proceeds to the step S508, wherein the CPU 201 requests reconnection to connect the MFP-X 104 to a redirect destination terminal, enabling telephone communication. On the other hand, if the connection request is for FAX transmission, the CPU 201 proceeds to the step S503, wherein the CPU 201 queries the user.

As described above, according to the present embodiment, when a connection request for the purpose of telephone communication is issued for connection to a redirect destination, it is possible to permit reconnection without querying a user, to enable telephone communication. The other constructions and advantageous effects of the present embodiment are the same as described hereinabove as to the first embodiment.

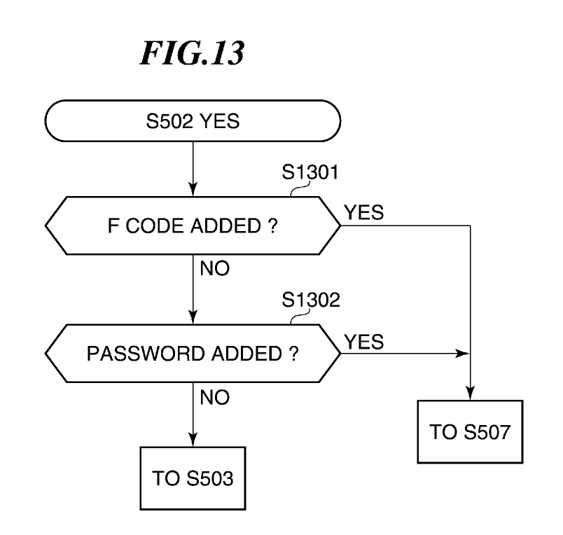

Next, an information processing apparatus according to a fifth embodiment will be described with reference to FIG. 13. It should be noted that component parts and elements identical or corresponding to those of the first embodiment will be denoted by identical reference numerals, and description thereof will be given using the figures referred to in describing the first embodiment.

In the present embodiment, redirect processing is controlled on a FAX transmission mode-by-FAX transmission mode basis. As the FAX transmission mode, there is not only a normal FAX transmission mode but also a confidential transmission mode in which data is transmitted after identifying a recipient user who receives data in advance.

In the confidential transmission mode, a recipient receives data, for example, not in a printed form, but in a state stored in a memory or box for use in confidential reception. Identification information, such as a password, is set in advance for the memory or box, so that when the identification information cannot be identified, the reading of the data stored in the memory or the box is not permitted.

In data transmission in the confidential transmission mode, an F code or a password defined by ITU-TT.30 as a standard of FAX communication protocol is used, and the F code or the password set in advance based on the FAX protocol data is transmitted before execution of FAX data transmission. The method of setting the F code or the password for confidential transmission is a known method, and therefore description thereof is omitted.

Next, a description will be given of a data transmission process executed by the MFP-X 104 which is a source terminal, with reference to FIG. 13. Processing in each step of the process in FIG. 13 is executed e.g. by the CPU 201, by loading a control program stored in the storage unit of the MFP-X 104, such as the ROM 208 or the HDD 210, into the RAM 209.

In the present embodiment, the data transmission process is identical to that (FIG. 5) in the first embodiment except that steps S1301 and S1302 are inserted between the steps S502 and S503 in FIG. 5, and therefore the following description will be given only of different points.

When an alternative address is notified by the 302 Moved Temporary Response returned from the SIP server 105, the CPU 201 determines in the step S502 that a redirect setting has been made, and proceeds to the step S1301.

In the step S1301, the CPU 201 determines whether or not data having an F code added thereto is to be transmitted.

If data having an F code added thereto is to be transmitted, the CPU 201 proceeds to the step S507, wherein the CPU 201 executes error handling and inhibits data transmission. On the other hand, if data without an F code is to be transmitted, the CPU 201 proceeds to the step S1302.

In the step S1302, the CPU 201 determines whether or not data having a password added thereto is to be transmitted.

If data having a password added thereto is to be transmitted, the CPU 201 proceeds to the step S507, wherein the CPU 201 executes error handling and inhibits data transmission. On the other hand, if data without a password is to be transmitted, the CPU 201 proceeds to the step S503, wherein the CPU 201 performs querying processing for querying the user.

As described above, according to the present embodiment, it is possible to provide a setting in advance such that data transmission to a redirect destination is inhibited when in the confidential transmission mode for transmitting important data having an F code or a password added thereto, and this makes it possible to prevent important data from being erroneously redirected. The other constructions and advantageous effects of the present embodiment are the same as described hereinabove as to the first embodiment.

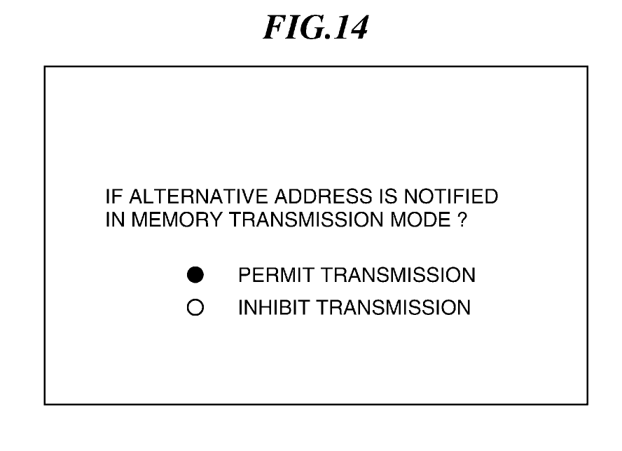

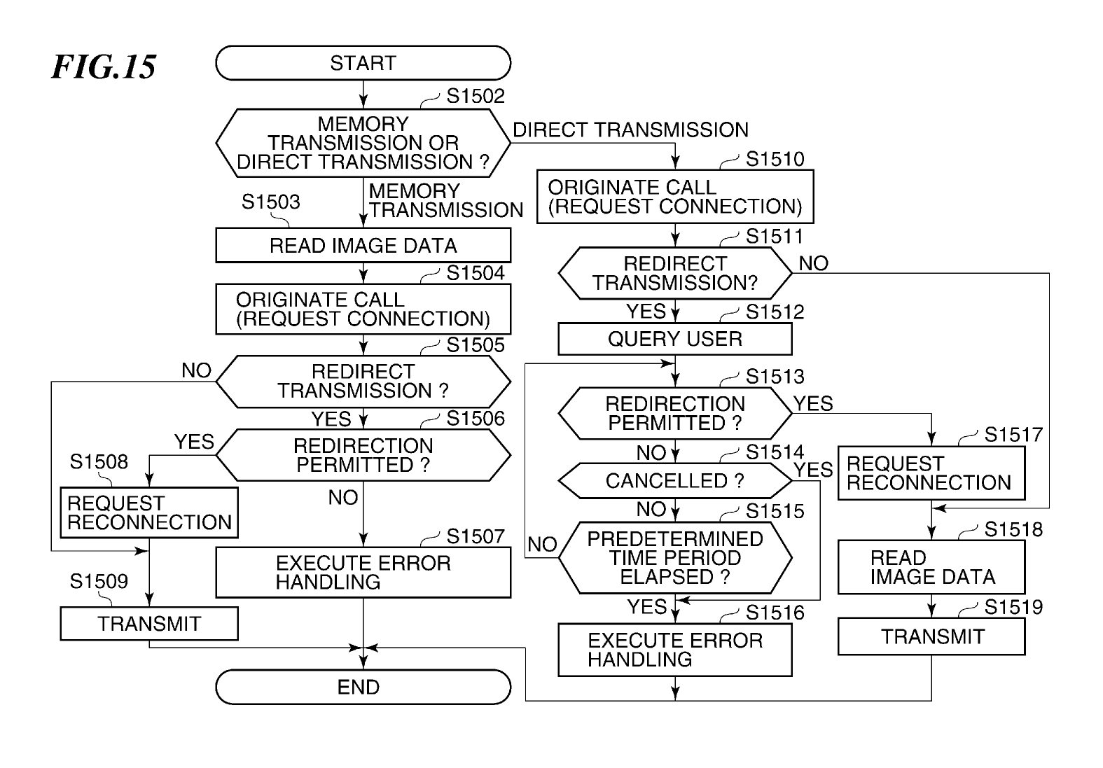

Next, an information processing apparatus according to a sixth embodiment will be described with reference to FIGS. 14 and 15. It should be noted that component parts and elements identical or corresponding to those of the first embodiment will be denoted by identical reference numerals, and description thereof will be given using the figures referred to in describing the first embodiment.

In the present embodiment, redirect processing is controlled on a FAX transmission mode-by-FAX transmission mode basis. In general, the FAX transmission (reading) mode is classified into a memory transmission mode in which data to be transmitted is all stored in a storage unit within an information processing apparatus and then line connection is established to transmit the stored data, and a direct transmission mode in which line connection is established first and then data transmission is performed while reading data.

In the direct transmission mode, read data is transmitted to a transmission destination on a real-time basis. The memory transmission mode is not intended for real-time transmission but for secure transmission, and the read data is stored in the storage unit until the data reaches a transmission destination.

For example, in the memory transmission mode, even when a communication error occurs due to an influence of noise on the line during transmission, connection to a transmission destination is automatically performed again to transmit the data the transmission of which has been interrupted due to the error. After the data transmission is completed without error, the data stored in the storage unit is erased. Such a function of error-handling retransmission is not provided for the direct transmission mode.

In the memory transmission mode, once data to be transmitted has been read by a FAX machine, a user is not required to stay by the FAX machine, and therefore the transmission is left to the FAX machine.

In the memory transmission mode described above, since a user does not necessarily stay by a MFP at the start of actual transmission (connection with a transmission destination), the query processing executed in the present invention for querying a user sometimes becomes useless.

To solve this problem, in the present embodiment, processing is differentiated between the memory transmission mode and the direct transmission mode, and in the memory transmission mode, whether or not to transmit data to an alternative address (redirect destination) is set in advance by a user operation.

If the permission of data transmission to an alternative address (redirect destination) is set by the user operation, the data transmission is performed, whereas if the inhibition of data transmission to the same is set by the user operation, the data transmission is inhibited.

FIG. 14 is a view illustrating an example of a configuration screen displayed on the display/operation section 203 of the MFP-X 104 in the memory transmission mode, for selection of whether or not to transmit data to an alternative address. The user configure the setting as to whether to permit or inhibit data transmission in the memory transmission mode, on this screen, in advance.

Next, a description will be given of a data transmission process executed by the MFP-X 104 which is a source terminal, with reference to FIG. 15. Processing in each step of the process in FIG. 15 is executed e.g. by the CPU 201, by loading a control program stored in the storage unit of the MFP-X 104, such as the ROM 208 or the HDD 210, into the RAM 209.

In a step S1502, the CPU 201 determines, based on a user operation, which of the memory transmission mode and the direct transmission mode has been selected. If the memory transmission mode has been selected, the CPU 201 proceeds to a step S1503, whereas if the direct transmission mode has been selected, the CPU 201 proceeds to a step S1510.

Processing in steps S1510 to S1517 is identical to that in the step S501 to S508 in FIG. 5, and therefore description thereof is omitted.

In a step S1518, the CPU 201 controls the scanner section 204 to read image data to be transmitted, and then proceeds to a step S1519.

In the step S1519, the CPU 201 transmits the image data read in the step S1518 to a redirect destination terminal, followed by terminating the present process.

On the other hand, in the step S1503, the CPU 201 controls the scanner section 204 to read image data to be transmitted and stores the read image data in the storage unit, such as the HDD 210, and then proceeds to a step S1504.

In the step S1504, the CPU 201 sends an INVITE request for establishment of a session to the SIP server 105, and then proceeds to a step S1505.

In the step S1505, the CPU 201 determines whether or not an alternative address is notified by a 302 Moved Temporary Response returned from the SIP server 105.

If no alternative address has been notified from the SIP server 105, the CPU 201 determines that a redirect setting has not been made, and proceeds to a step S1509. In the step S1509, the CPU 201 transmits the image data stored in the step S1503, followed by terminating the present process. On the other hand, if an alternative address has been notified by the SIP server 105, the CPU 201 determines that a redirect setting has been made, and proceeds to a step S1506.

In the step S1506, the CPU 201 determines which has been set on the FIG. 14 configuration screen, permission or inhibition of data transmission to an alternative address, in the memory transmission mode.

If the permission of the data transmission has been set, the CPU 201 proceeds to a step S1508, whereas if the inhibition of the transmission has been set, the CPU 201 proceeds to a step S1507.

In the step S1507, the CPU 201 causes the display/operation section 203 to display the message indicating that the transmission has been stopped e.g. as shown in FIG. 7, to thereby execute error handling, followed by terminating the present process without executing data transmission.

In the step S1508, the CPU 201 sends an INVITE request to establish a session with the redirect destination address, to the SIP server 105, and then proceeds to the step S1509.

In the step S1509, the CPU 201 transmits the image data stored in the step S1503, followed by terminating the present process.

As described above, according to the present embodiment, in the memory transmission mode, a user can select and set whether or not to permit data transmission to a redirect destination. This makes it possible to perform efficient transmission control without carrying out useless query processing for querying the user, in the memory transmission mode. The other constructions and advantageous effects of the present embodiment are the same as described hereinabove as to the first embodiment.

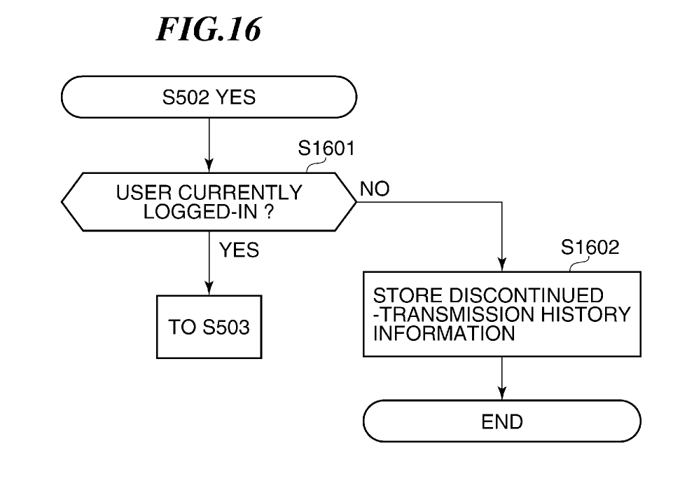

Next, an information processing apparatus according to a seventh embodiment of the present invention will be described with reference to FIGS. 16 to 18. It should be noted that component parts and elements identical or corresponding to those of the first embodiment will be denoted by identical reference numerals, and description thereof will be given using the figures referred to in describing the first embodiment.

In the present embodiment, user authentication is performed to permit operation of the MFP-X 104 (information processing apparatus) only by a user authorized in advance to use the MFP-X 104, e.g. by causing the user to log in to the apparatus or identifying the user by a special card and a unit for reading the card.

FIG. 16 is a flowchart of a data transmission process executed by the MFP-X 104 as a source terminal. Processing in each step of the process in FIG. 16 is executed e.g. by the CPU 201, by loading a control program stored in the storage unit of the MFP-X 104, such as the ROM 208 or the HDD 210, into the RAM 209.

In the present embodiment, the data transmission process is identical to that (FIG. 5) in the first embodiment except that steps S1601 and S1602 are inserted between the steps S502 and S503 in FIG. 5, and therefore the following description will be given only of different points.

When an alternative address is notified by the 302 Moved Temporary Response returned from the SIP server 105, the CPU 201 determines in the step S502 that a redirect setting has been made, and proceeds to the step S1601.

In the step S1601, the CPU 201 determines whether or not a user currently using the MFP-X 104 has been authenticated i.e. has logged in to the MFP-X 104.

If the user has been authenticated, the CPU 201 proceeds to the step S503, wherein the CPU 201 performs querying processing for querying the user. On the other hand, if the user has not been authenticated, i.e. has not logged in, the CPU 201 proceeds to the step S1602:

When the transmission request is from a user who has not logged in, the query processing to be executed in the step S503 for querying a user whether or not to permit redirection comes to nothing.

Therefore, in the step S1602, the CPU 201 stores discontinued-transmission history information including a user ID, a user name, the job number of a job which the non-logged-in user attempted to send, in the storage unit, such as the HDD 210, and terminates the present process without transmitting data. In this case, the data transmission which is executed even though the user has not logged-in is assumed to be, for example, time-designated transmission, error-handling retransmission mentioned in the memory transmission mode, etc.

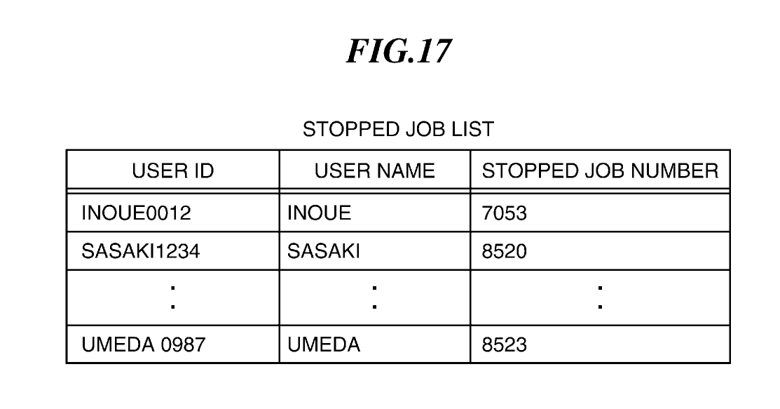

FIG. 17 is a diagram showing an example of the discontinued-transmission history information stored in the step S1602. The illustrated example includes at least the user IDs and user names of respective users who instructed transmission, and the job numbers of respective associated transmission jobs. A portion of the FIG. 17 discontinued-transmission history information associated with a user is notified to the user e.g. by displaying the same on the display/operation section 203 when the user has logged in afterwards.

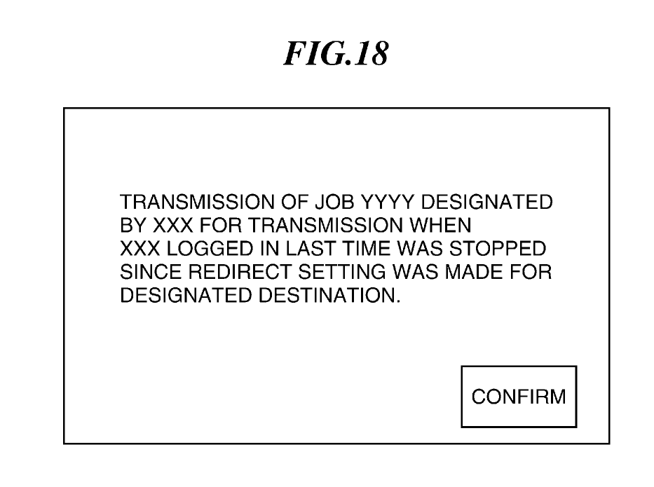

FIG. 18 is a view illustrating an example of a notification screen for displaying a notification of the user-associated portion of the discontinued-transmission history information, to a user. This notification screen is configured, based on the FIG. 17 discontinued-transmission history information, to notify a user who attempted transmission of the fact that transmission was stopped due to a redirect setting. In FIG. 17, XXX represents a user name, and YYYY represents the job number of a stopped job.

As described above, according to the present embodiment, in a case where the transmission process is executed when a user is in an authenticated state, such as when a specific user in a logged-in state, the user is queried as to whether or not to permit redirection of data for transmission.

If the user is not in an authenticated (logged-in) state, the redirection is stopped, and the user ID and user name of the user who issued the job, and the job number of the job are stored. Then, when the user logs in again, the user is notified that the transmission was stopped.

This makes it possible to prevent data from being carelessly transmitted to a redirect destination. The other constructions and advantageous effects of the present embodiment are the same as described hereinabove as to the first embodiment.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-172209, filed Jul. 23, 2009, which is hereby incorporated by reference herein in its entirety.

What is claimed is:

1. An information processing apparatus that performs data transmission using SIP as a communication control protocol, comprising:
a judgment unit adapted to judge whether or not a redirect setting for redirecting data to a redirect destination terminal has been made concerning a destination terminal as a data transmission destination;
an inquiry unit adapted to be operable when said judgment unit judges that the redirect setting has been made, to query a user whether or not to permit data transmission to the redirect destination terminal, for selection; and
a transmission control unit adapted to be operable when permission of the data transmission to the redirect destination terminal has been selected via said inquiry unit, to permit the data transmission to the redirect destination terminal.

2. The information processing apparatus according to claim 1, comprising a first setting unit adapted to be operable when said judgment unit judges that the redirect setting has been made, to set, according to a user operation, whether or not to execute processing by said inquiry unit, and
a second setting unit adapted to be operable when not to execute the processing by said inquiry unit has been set by said first setting unit, to designate, according to a user operation, whether or not to permit the data transmission to the redirect destination terminal.

3. The information processing apparatus according to claim 1, comprising a storage unit adapted to store a permitted address list of redirect destinations to which data transmission is permitted and an inhibited address list of redirect destinations to which data transmission is inhibited,
a check unit adapted to be operable when said judgment unit judges that the redirect setting has been made, to check a redirect destination address against the address lists stored in said storage unit, and
a control unit adapted to permit the data transmission to the redirect destination terminal without executing the processing by said inquiry unit when a result of checking by said check unit shows that the redirect destination address exists in the permitted address list, and inhibit the data transmission without executing the processing by said inquiry unit when the result of checking by said check unit shows that the redirect destination address exists in the inhibited address list.

4. The information processing apparatus according to claim 1, comprising a determining unit adapted to be operable when said judgment unit judges that the redirect setting has been made, to determine whether a connection request is for telephone communication or for data transmission, and
a control unit adapted to be operable when said determining unit determines that the connection request is for telephone communication, to permit telephone communication with the redirect destination without executing the processing by said inquiry unit.

5. The information processing apparatus according to claim 1, comprising a determining unit adapted to be operable when said judgment unit judges that the redirect setting has been made, to determine whether or not data having identification information added thereto is to be transmitted, and
a control unit adapted to be operable when said determining unit determines that the data having identification information added thereto is to be transmitted, to inhibit the data transmission without executing the processing by said inquiry unit.

6. The information processing apparatus according to claim 1, comprising a determining unit adapted to be operable when said judgment unit judges that the redirect setting has been made, to determine whether or not the user has been authenticated,
a control unit adapted to execute the processing by said inquiry unit when said determining unit determines that the user has been authenticated, and inhibit the data transmission without executing the processing by said inquiry unit when said determining unit determines that user has not been authenticated, and
a notification unit adapted to be operable when a user who was determined by said determining unit that the user had not been authenticated to have the associated data transmission inhibited by said control unit performs data transmission afterwards, to notify the user that the associated data transmission was inhibited, when said determining unit determines that user has been authenticated.

7. A method of controlling an information processing apparatus that performs data transmission using SIP as a communication protocol, comprising:
judging whether or not a redirect setting for redirecting data to a redirect destination terminal has been made concerning a destination terminal as a data transmission destination;
querying, when it is judged that the redirect setting has been made, a user whether or not to permit data transmission to the redirect destination terminal, for selection; and
permitting, when permission of the data transmission to the redirect destination terminal has been selected, the data transmission to the redirect destination terminal.

8. A non-transitory computer-readable storage medium storing a program for causing a computer to execute a method of controlling an information processing apparatus which performs data transmission using SIP as a communication protocol,
wherein the method comprises:
judging whether or not a redirect setting for redirecting data to a redirect destination terminal has been made concerning a destination terminal as a data transmission destination;
querying, when it is judged that the redirect setting has been made, a user whether or not to permit data transmission to the redirect destination terminal, for selection; and
permitting, when permission of the data transmission to the redirect destination terminal has been selected, the data transmission to the redirect destination terminal.
